(19) United States
(12) Patent Application Publication
(10) Pub. No.: US 2010/0098169 A1
(43) Pub. Date: Apr. 22, 2010

(54) METHOD AND APPARATUS FOR MOTION ESTIMATION USING COMPRESSED REFERENCE FRAME

(75) Inventor: Madhukar Budagavi, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/580,111

(22) Filed: Oct. 15, 2009

Related U.S. Application Data
(60) Provisional application No. 61/106,004, filed on Oct. 16, 2008.

(51) Int. Cl. H04N 7/26

(52) U.S. Cl. 375/240.16; 375/E07.125

(57) ABSTRACT

An apparatus and a method for determining motion estimation with compressed frame, the method includes loading a macroblock of a current image into codec, transferring a compressed version of motion estimation search window data from previous frame to codec, and carrying out motion estimation to calculate motion vector for current macroblock by matching block to uncompressed version of previous frame data in search window.

### CROSS-REFERENCE TO RELATED APPLICATIONS

This application claims benefit of U.S. provisional patent application Ser. No. 61/106,004, filed Oct. 16, 2008, which is herein incorporated by reference.

### BACKGROUND OF THE INVENTION

1. Field of the Invention

Embodiments of the present invention generally relate to a method and apparatus for estimating motion using compressed reference frames.

2. Description of the Related Art

Portable video devices such as camera phones, digital still cameras, personal media players etc. have become very popular recently. Battery life and cost are key concerns for portable video devices. Power consumed in a video codec depends on computational complexity, as well as, memory access bandwidth. Cost depends on memory size. So, techniques for reducing memory size and memory bandwidth are important for video coding on portable video devices.

Memory bandwidth is one of the key limiting factors for motion estimation in high-definition (HD) video coding. Memory bandwidth typically determines the motion vector search range in video CODEC with hardware accelerators and, hence, it impacts resulting video quality.

Techniques that reduce memory bandwidth during motion estimation are desirable for reducing cost and power and for increasing quality in HD video solutions. Furthermore, there is a need for an improved method and apparatus that reduces memory bandwidth for motion estimation without significantly degrading the quality or increasing the bitrate. Moreover, it is preferable that the improvement is not restricted to an existing coding standard.

### SUMMARY OF THE INVENTION

Embodiments of the present invention relate to a method and apparatus for determining motion estimation with compressed frame, the method includes loading a macroblock of a current image into codec, transferring a compressed version of motion estimation search window data from previous frame to codec, and carrying out motion estimation to calculate motion vector for current macroblock by matching block to uncompressed version of previous frame data in search window.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment of a block diagram of a video encoder for motion estimation using compressed frame buffers;

FIG. 2 is another embodiment of a block diagram of video encoder using motion compensation DCT technique; and

FIG. 3 is an embodiment of a flow diagram for a method for determining motion estimation with compressed frame; and

FIG. 4 is an embodiment of a sliding window memory access.

### DETAILED DESCRIPTION

Memory bandwidth is one of the key limiting factors for motion estimation in high-definition (HD) video coding. Memory bandwidth typically determines the motion vector search range in video CODECS with hardware accelerators and, hence, it impacts resulting video quality. Techniques that reduce memory bandwidth during motion estimation are desirable for reducing cost and power and for increasing quality in HD video solutions.

In one embodiment, a lossy fixed length compression scheme may be used to compress the reference frame before storing it in SDRAM and decompressing it before using it in motion estimation. In such an embodiment, the motion compensation may be carried out on the uncompressed version of reference frames and, hence, may be used with all existing video coding standards.

For example, when using the JVT JM H.264 full search motion estimation algorithm on 10 D1 resolution video clips, the memory bandwidth reduction technique achieves memory bandwidth reduction at the cost of 0.03 dB degradation in PSNR or equivalently a 0.93% increase in bitrate. The savings in memory bandwidth may be achieved at a cost of increased memory requirements (i.e. about half the size of reference frame) and the additional complexity of our low-complexity lossy compression scheme used to compress reference frame buffers.

In one embodiment, the technique used for compressing reference frames is a fixed-length compression scheme. Fixed-length compression allows for random access of memory blocks which is useful in motion estimation. In this embodiment, the fixed-length compression scheme operates on 4×4 pixel blocks. The minimum and maximum pixel values may be calculated for each block and uniformly quantize all the pixels in the 4×4 block to be between the minimum and maximum pixel values. Data stored for each block of 4×4 pixels may consist of the minimum and maximum pixel values of the block (i.e. the minimum and maximum values are stored with 8 bits each) and the scalar quantized indices for each pixel (i.e. 16 indices in total). Note that other more complex compression techniques such as Entropy coded quantization, ADPCM, and VQ can be used too.

Table 1 below shows an embodiment of the rate-distortion performance of our min/max scalar quantization scheme (MMSQ) on 10 D1 video sequences. From Table 1, one may note that the MMSQ technique provides a relatively high average PSNR value of 38.44 dB at even 4 bits per pixel. Hence, one may anticipate that there may be some degradation in PSNR and bitrate when one uses the MMSQ technique for quantizing the reference frames in the motion estimation stage.

TABLE 1
Rate-distortion performance of MMSQ listing PSNR-Y values at various bits-per-pixel.

| | | Min-max, | Min-max, | Min-max, | Min-max, |
|---|---|---|---|---|---|
| | | Scalar Q, | Scalar Q, | Scalar Q, | Scalar Q, |
| | Num | 3 bpp | 4 bpp | 5 bpp | 6 bpp |
| Sequence | Frames | (PSNR dB) | (PSNR dB) | (PSNR dB) | (PSNR dB) |
| football_p704x480 | 150 | 32.969264 | 39.749282 | 45.983451 | 51.984504 |
| harryPotter_p720x480 | 150 | 31.285029 | 37.884567 | 44.101559 | 50.028192 |
| ICE_704x576_30_orig_02 | 239 | 33.883506 | 39.011147 | 44.210051 | 49.763217 |
| mobile_p704x480 | 150 | 26.883126 | 33.978324 | 40.345346 | 46.451883 |
| SOCCER_704x576_30_orig_02 | 255 | 31.795858 | 38.263099 | 44.445286 | 50.428366 |
| starwars17clean_720x480. | 100 | 36.704894 | 43.131189 | 49.196297 | 55.006248 |
| CREW_704x576_30_orig_01.yuv | 255 | 32.620265 | 39.432153 | 45.577077 | 51.283966 |
| HARBOUR_704x576_30_orig_01.yuv | 255 | 28.050781 | 35.381261 | 41.913565 | 47.961625 |
| tennis_p704x480.yuv | 150 | 28.644174 | 36.018527 | 42.476728 | 48.493588 |
| fire_p720x480.YUV | 99 | 35.02409 | 41.570398 | 47.685407 | 53.350462 |
| Average PSNR (dB) | | 31.786099 | 38.441995 | 44.593477 | 50.475205 |

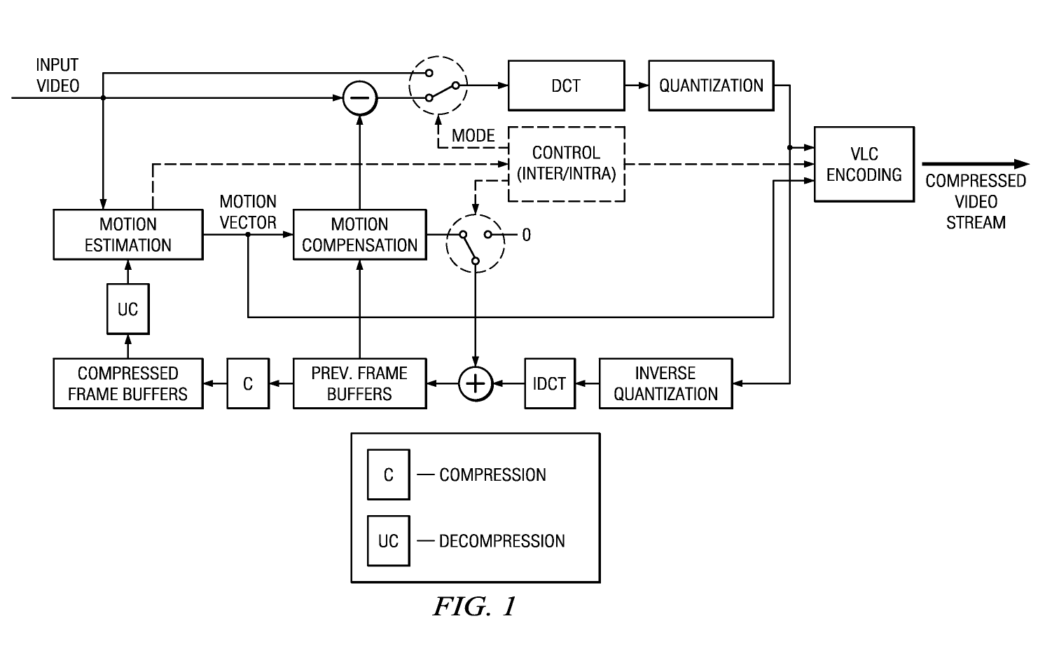

FIG. 1 is an embodiment of a block diagram of a typical video encoder for motion estimation using compressed frame buffers. FIG. 1 depicts a block diagram of a typical video encoder with an embodiment for reducing memory bandwidth by using compressed reference frames in motion estimation. In this embodiment, the reference frame is compressed and stored in SDRAM.

During motion estimation, the compressed data is read from SDRAM and decompressed into on-chip memory before using it for motion estimation. In one embodiment, the MMSQ technique may be used to compress the reference frames. Thus, the reference frame may be compressed to 4 bpp. Hence, a 50% reduction in memory bandwidth is achieved for memory reads during motion estimation.

However, in one embodiment additional bandwidth may be incurred for storing the compressed reference frames. The overall motion estimation memory bandwidth saved depends on the motion estimation algorithm used. Thus, in one embodiment, the algorithm reduces the motion estimation memory bandwidth by an estimated 40% for motion estimation algorithms that use sliding window approach for loading search window as shown in FIG. 4. In FIG. 4, the solid line box shows the search window for a previous macroblock and the dashed line box shows the search window for current macroblock. After the macroblock is processed, the sliding window moves to right by one column of macroblocks. The search data that is present in the overlap between current search window and previous search window is cached and reused for current macroblock.

In one embodiment, only the search data that is not in cache is loaded. For example, let (C, H) be the (width, height) of sliding window. The memory bandwidth for load search window without sliding window approach is C*H and is equal to 16*H when sliding window is used. When 4 bpp is used for compression, the memory bandwidth for loading search window becomes 16*H/2. However additional bandwidth of 16*16/2 is required to store compressed macroblock. So the total savings is bandwidth is:

(16*H−(16*H/2+16*16/2))/(16*H)

For a search window size of H=80 which corresponds to a typical search range of +/−32, we achieve bandwidth savings of 40%.

Table 2 lists the average rate-distortion performance of such a technique, which may achieve memory bandwidth reduction at the cost of 0.03 dB degradation in PSNR or equivalently a 0.93% increase in bitrate. Table 3 lists the detailed rate-distortion data used to calculate the average data presented in Table 2.

TABLE 2
Rate distortion performance of H.264 with compressed reference frames in motion estimation,
ΔBitrate is bitrate increase and ΔPSNR is PSNR-Y degradation

| | | | Estimated memory |
|---|---|---|---|
| | Compressed reference frames | | bandwidth savings |
| | (4 bpp - Max/Min SQ) | | Sliding window |
| | ΔBitrate | ΔPSNR | based ME algo |
| Sequence | (BD delta) | (BD delta) | with H = 80 |
| football_p704x480 | 0.49% | −0.019 | 40% |
| harryPotter_p720x480 | 1.36% | −0.06 | 40% |
| ICE_704x576_30_orig_02 | 1.66% | −0.064 | 40% |
| mobile_p704x480 | 0.90% | −0.042 | 40% |
| SOCCER_704x576_30_orig_02 | 1.13% | −0.045 | 40% |
| starwars17clean_720x480. | 1.01% | −0.033 | 40% |
| CREW_704x576_30_orig_01.yuv | 0.54% | −0.018 | 40% |
| HARBOUR_704x576_30_orig_01.yuv | 1.03% | −0.044 | 40% |
| tennis_p704x480.yuv | 0.78% | −0.028 | 40% |
| fire_p720x480.YUV | 0.42% | −0.015 | 40% |
| Average | 0.93% | −0.0368 | 40% |

TABLE 3
Rate-distortion data used to calculate the average
rate-distortion performance presented in Table 2.

| | | No memory | | Compressed | |
|---|---|---|---|---|---|
| | | bandwidth | | reference frames | |
| | | compression (8 bpp) | | (4 bpp - Max/Min SQ) | |
| Sequence | QP | Bitrate | PSNRY | Bitrate | PSNRY |
| football_p704x480 | 22 | 7943.23 | 40.43 | 7965.89 | 40.42 |
| | 27 | 3759.95 | 36.95 | 3778.48 | 36.95 |
| | 32 | 1727.41 | 33.97 | 1730.08 | 33.96 |
| | 37 | 856.59 | 31.7 | 859.2 | 31.69 |
| harryPotter_p720x480 | 22 | 5175.61 | 41.63 | 5205.47 | 41.61 |
| | 27 | 2191.03 | 38.15 | 2214.16 | 38.13 |
| | 32 | 1053.28 | 34.83 | 1060.32 | 34.8 |
| | 37 | 550.37 | 31.78 | 553.2 | 31.75 |
| ICE_704x576_30_orig_02 | 22 | 2287.56 | 42.87 | 2314.65 | 42.85 |
| | 27 | 1087.19 | 40.59 | 1100.04 | 40.56 |
| | 32 | 574.74 | 38.07 | 579.3 | 38.04 |
| | 37 | 336.61 | 35.47 | 339.21 | 35.46 |
| mobile_p704x480 | 22 | 11973.41 | 38.88 | 12023.4 | 38.85 |
| | 27 | 6089.74 | 34.8 | 6116.54 | 34.77 |
| | 32 | 2741.63 | 30.71 | 2751.37 | 30.69 |
| | 37 | 1022.48 | 27.06 | 1025.2 | 27.04 |
| SOCCER_704x576_30_orig_02 | 22 | 6299.39 | 40.75 | 6325.01 | 40.73 |
| | 27 | 2642.6 | 37.25 | 2661.31 | 37.23 |
| | 32 | 1191.55 | 34.05 | 1201.11 | 34.03 |
| | 37 | 605.49 | 31.47 | 607.66 | 31.46 |
| starwars17clean_720x480. | 22 | 799.63 | 44.38 | 803.92 | 44.37 |
| | 27 | 348.88 | 42.12 | 350.76 | 42.1 |
| | 32 | 168.2 | 39.63 | 168.64 | 39.6 |
| | 37 | 91.63 | 37.17 | 91.51 | 37.15 |
| CREW_704x576_30_orig_01.yuv | 22 | 7371.65 | 40.97 | 7387.04 | 40.96 |
| | 27 | 3100.6 | 38.12 | 3109.18 | 38.11 |
| | 32 | 1461.07 | 35.56 | 1466.19 | 35.55 |
| | 37 | 743.5 | 33.1 | 745.07 | 33.1 |
| HARBOUR_704x576_30_orig_01.yuv | 22 | 11445.31 | 39.78 | 11453.82 | 39.74 |
| | 27 | 5528.53 | 36.21 | 5547.91 | 36.19 |
| | 32 | 2378.48 | 32.63 | 2390.15 | 32.6 |
| | 37 | 963.02 | 29.24 | 967.65 | 29.21 |
| tennis_p704x480.yuv | 22 | 9948.45 | 38.52 | 9982.57 | 38.5 |
| | 27 | 4530.58 | 34.79 | 4548.68 | 34.78 |
| | 32 | 1837.62 | 31.55 | 1841.82 | 31.53 |
| | 37 | 633.24 | 28.84 | 634.23 | 28.82 |
| fire_p720x480.YUV | 22 | 6202.56 | 42.57 | 6218.26 | 42.56 |
| | 27 | 2891.88 | 39.43 | 2897 | 39.41 |
| | 32 | 1298.36 | 36.41 | 1300.77 | 36.41 |
| | 37 | 588.03 | 33.73 | 586.49 | 33.72 |

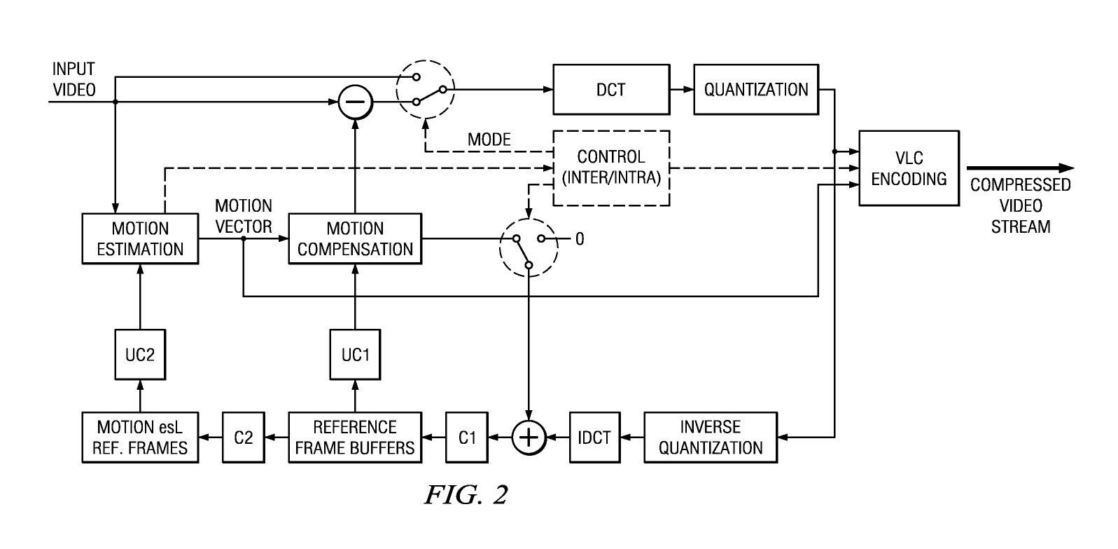

FIG. 2 is another embodiment of a block diagram of video encoder using motion compensation DCT technique. In FIG. 2, compression C1 and C2 and the corresponding decompression blocks UC1 and UC2 are shown. One may choose to use the combination (C1, UC1) or (C2, UC2) or both. C1 and C2 may be either fixed length coding schemes or variable length coding schemes. C1 and C2 may either be lossy or lossless schemes.

In the case of (C1, UC1) only, the reference frame compression and decompression may be carried out in the core motion compensation loop and repeated by both the encoder and decoder. Hence, there is no drift between the encoder and decoder even when C1 is lossy. There is a savings in memory access bandwidth in both encoder and decoder. There is a savings in memory size required to store reference frames too.

In the case of (C2, UC2) only, the compression and decompression may be carried out outside the motion compensation loop. This prevents the drift between encoder and decoder. There is a savings in the memory access bandwidth in the encoder only. But these savings may come at a cost of increased memory size required to store motion estimation reference frames, as shown in FIG. 2.

In the case of (C1, UC1) and (C2, UC2), the reference frame compression and decompression is carried out both inside and outside the motion compensation loop. This technique provides the maximum bandwidth savings when compared to (C1, UC1) only and (C2, UC2) only.

A fixed length compression (FLC) scheme or a variable length compression (VLC) scheme may be used for C1 and C2. When using fixed length compression, one maintains random access of any block of pixels in memory. This is desirable in motion compensation since motion vectors in video coding standards may point to anywhere in the picture. One technique that we use for compressing reference frame is block scalar quantization shown in MMSQ encode below, wherein a block of 4×4 pixels is being operated on. The minimum and maximum pixel values are calculated and all the pixels in the block are quantized uniformly to lie between the minimum and maximum. The algorithm is termed as min-max-scalar-quantization (MMSQ) scheme. Other fixed-length compression algorithms, such as, vector quantization and ADPCM, may be used as well. The block sizes may be arbitrary and also the bits used per pixel can vary (i.e. N and L can vary).

Variable Length Compression (VLC) may provide a better compression ratio when compared to FLC. VLC may involve a combination of one or more of the following components: transforms, prediction, quantization, and entropy coding. When VLC is used, random access at block level becomes difficult because of the variable length nature of the coding. A table of coded block lengths may be required to achieve random access at block level. This table may have to be read before doing any memory access. This would impose a significant overhead on memory accesses. Thus, one may constrain random access to be at a macroblock row level; in which case, only a table of macroblock row lengths may need to be store thereby reducing overhead involved in memory accesses significantly.

Constraining random access to be only at macroblock row level requires having enough internal memory to store multiple rows of macroblocks. The number of rows of macroblocks that needs to be stored in the encoder depends on the vertical motion vector search range. A new row of macroblocks is loaded in the encoder when ME of the leftmost macroblock of that row is carried out. The oldest row of macroblock is discarded. This results in a sliding window of rows of macroblocks. In the decoder, the issue is more complicated when variable length coding is adopted since the motion vector can point to any location in memory. Hence, to resolve the problem, the following may occur:
Restrict vertical motion vector range in the encoder, such that, using a sliding macroblock rows window approach becomes possible in the decoder by using enough internal memory. With this approach, one may save bandwidth in both the encoder and decoder.
Impose no restriction on vertical motion vector range: In this case, one may store the reference frame in compressed format and uncompressed format. If the motion vector lies in the region of multiple rows of macroblocks stored in internal memory then the internal memory is used to read the motion compensated data. If the motion vector lies outside the region, then the uncompressed data is read from external memory.
Overall, this scheme provides savings since the number of times that we need to go to external memory is limited.

Any variable length compression scheme may be used to implement VLC of reference frames. Some example compression schemes are provided below, wherein entropy coding refers to any one or combination of the exp-Golomb coding, Huffman coding, or arithmetic coding:
DPCM/ADPCM+entropy coding
Block scalar quantization+DPCM between blocks+entropy coding
Entropy constrained vector quantization
Block transforms (such as simple Hadamard transform or DCT)+Quantization+entropy coding

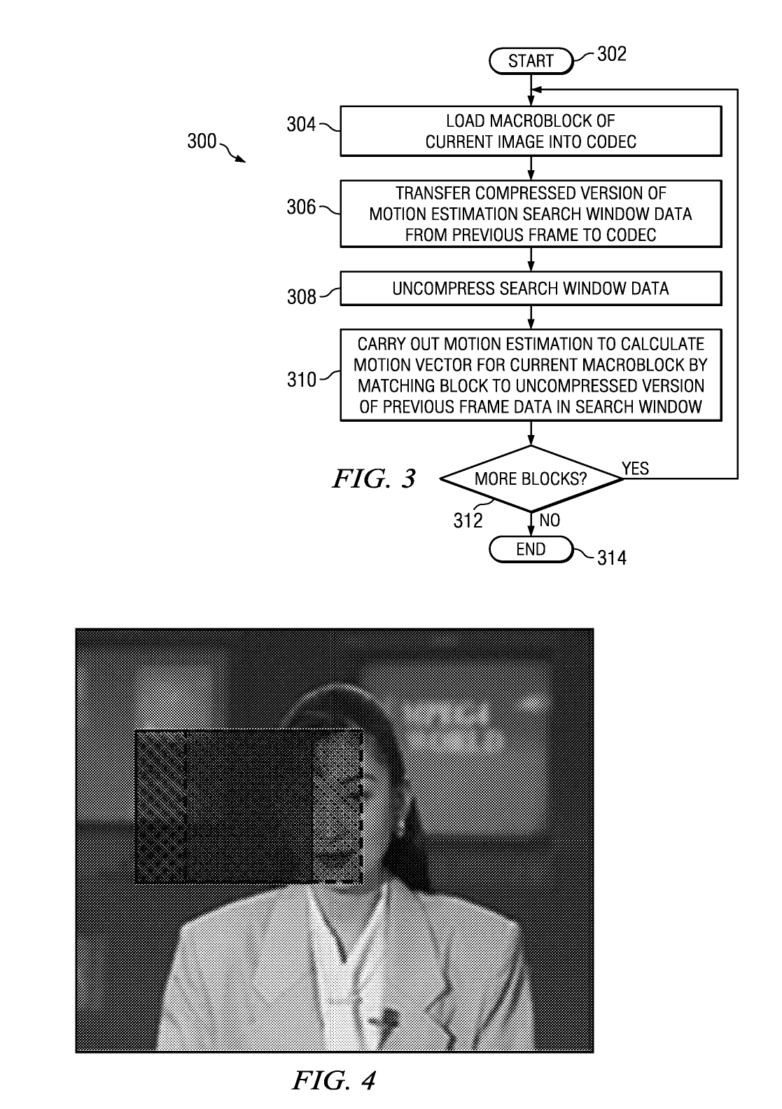

FIG. 3 in an embodiment of a flow diagram for a method 300 for determining motion estimation with compressed frame. The method 300 starts at step 302 and proceeds to step 304. At step 304, the method 304 loads macroblock of a current image into codec. At step 306, the method 300 transfers compressed version of motion estimation search window data from previous frame to codec. At step 308, the method 300 carries out motion estimation to calculate motion vector for current macroblock by matching block to uncompressed version of previous frame data in search window. At step 312, the method 300 determines if there are more blocks. If there are more blocks, the method 300 proceeds to step 304; otherwise, the method 300 proceeds to step 314. At step 314, the method 300 ends.

While the foregoing is directed to embodiments of the present invention, other and further embodiments of the invention may be devised without departing from the basic scope thereof, and the scope thereof is determined by the claims that follow.

What is claimed:

1. A method for a digital signal process for determining motion estimation with compressed frame, the method comprising:
loading a macroblock of a current image into codec;
transferring a compressed version of motion estimation search window data from previous frame to codec; and
carrying out motion estimation to calculate motion vector for current macroblock by matching block to uncompressed version of previous frame data in search window.

2. The method of claim 1, wherein the method utilizes motion compensation DCT technique.

3. The method of claim 2, wherein the method utilizes more than one compression.

4. The method of claim 1 further comprising at least one of:
restricting vertical motion vector range in the encoder and utilizing a sliding macroblock rows window; and
imposing no restriction on vertical motion vector range

5. The method of claim 4, wherein the step of imposing no restriction comprises at least one of:
storing the reference frame in compressed format and uncompressed format;
if the motion vector lies in the region of multiple rows of macroblocks stored in internal memory, utilizing the internal memory for reading the motion compensated data; and
if the motion vector lies outside the region, reading the uncompressed data from external memory.

6. An apparatus for determining motion estimation with compressed frame, the method comprising:
means for loading a macroblock of a current image into codec;
means for transferring a compressed version of motion estimation search window data from previous frame to codec; and
means for carrying out motion estimation to calculate motion vector for current macroblock by matching block to uncompressed version of previous frame data in search window.

7. The apparatus of claim 6, wherein the apparatus utilizes motion compensation DCT technique.

8. The apparatus of claim 7, wherein the apparatus utilizes more than one compression.

9. The apparatus of claim 6 further comprising at least one of:
means for restricting vertical motion vector range in the encoder and utilizing a sliding macroblock rows window; and
means for imposing no restriction on vertical motion vector range

10. The apparatus of claim 9, wherein the step of imposing no restriction comprises at least one of:
means for storing the reference frame in compressed format and uncompressed format;
means for utilizing the internal memory for reading the motion compensated data, wherein said means is utilized when the motion vector lies in the region of multiple rows of macroblocks stored in internal memory; and
means for reading the uncompressed data from external memory, wherein said means is utilized when the motion vector lies outside the region.

11. A computer readable medium comprising computer instructions, when executed, perform a method for determining motion estimation with compressed frame, the method comprising:
loading a macroblock of a current image into codec;
transferring a compressed version of motion estimation search window data from previous frame to codec; and
carrying out motion estimation to calculate motion vector for current macroblock by matching block to uncompressed version of previous frame data in search window.

12. The computer readable of claim 11, wherein the method utilizes motion compensation DCT technique.

13. The computer readable of claim 12, wherein the method utilizes more than one compression.

14. The computer readable of claim 11, wherein the method further comprising at least one of:
restricting vertical motion vector range in the encoder and utilizing a sliding macroblock rows window; and
imposing no restriction on vertical motion vector range

15. The computer readable of claim 14, wherein the step of imposing no restriction comprises at least one of:
storing the reference frame in compressed format and uncompressed format;
if the motion vector lies in the region of multiple rows of macroblocks stored in internal memory, utilizing the internal memory for reading the motion compensated data; and
if the motion vector lies outside the region, reading the uncompressed data from external memory.
